(19) United States
(12) Patent Application Publication
(10) Pub. No.: US 2018/0282999 A1
(43) Pub. Date: Oct. 4, 2018

(54) FIRE RESISTANT BUILDING PANELS

(71) Applicant: James Hardie Technology Limited, Dublin (IE)

(72) Inventors: Padmaja Parakala, Rosehill (AU); Andrew Durant, Rosehill (AU); John Cottier, Rosehill (AU); Mary Tysoe, Rosehill (AU); James Gleeson, Rosehill (AU)

(21) Appl. No.: 15/942,388

(22) Filed: Mar. 30, 2018

(30) Foreign Application Priority Data
Mar. 31, 2017 (AU) 2017901178

(51) Int. Cl. E04B 1/94; E04B 2/00; E04C 2/04; B32B 13/02; B32B 13/04; B32B 13/14; B32B 38/00; B32B 37/02

(52) U.S. Cl. CPC E04B 1/942; B32B 2607/00; E04C 2/044; B32B 13/02; B32B 13/04; B32B 13/14; B32B 38/00; B32B 37/02; B32B 2038/0076; B32B 2250/03; B32B 2262/14; B32B 2262/10; B32B 2305/72; B32B 2305/74; B32B 2305/30; B32B 2307/3065; B32B 2315/06; B32B 2317/18; E04C 2/44

(57) ABSTRACT

A fire resistant building panel comprising: a first major face; a second major face; and a fire resistant body comprising a binder, at least one additive, and at least one fiber material, wherein the binder comprises a calcareous material and a siliceous material; and wherein the fire resistant body is disposed between the first major face and the second major face. The fire resistant body provides a fire rating of at least 45 minutes as tested in accordance with Australian Standard AS1530.4-2005.

### CROSS-REFERENCE TO RELATED APPLICATIONS

Any and all applications for which a foreign or domestic priority claim is identified in the Application Data Sheet as filed with the present application are hereby incorporated by reference under 37CFR 1.57.

### BACKGROUND

### Field

The present disclosure generally relates to building panels and more specifically to fire resistant building panels.

While the present disclosure has been developed primarily for use as a fire resistant building panel for use in wall construction and will be described hereinafter with reference to this particular application, it will be appreciated that the present disclosure is not limited to this particular field of use.

### Description of the Related Art

Any discussion of the prior art throughout the specification should in no way be considered as an admission that such prior art is widely known or forms part of the common general knowledge in the field.

Fire resistant materials are known for use in building construction, and are generally disposed beneath a cladding material. An example of such materials include insulation fiber batts. However, such exemplary materials have no mechanical strength or weatherability. Consequently such materials cannot be exposed to the weather. Furthermore, such materials cannot provide an exterior cladding for a building.

Building panels are also common in the building industry, but generally do not perform auxiliary functions. They are intended to provide durability through resistance to weather element exposure, and may also provide mechanical strength required to resist wind loading, static loading and other physical forces that a building cladding encounters in service.

Fire rated wall constructions generally require the use of a combination of materials sourced from different suppliers, and applied to the building for different purposes. Performance of the resulting construction is heavily reliant on the diligence of individual installers.

### SUMMARY

The systems, methods, and devices disclosed herein address one or more problems as described above and associated with fire resistant building systems. The systems, methods, and devices described herein have innovative aspects, no single one of which is indispensable or solely responsible for their desirable attributes. Without limiting the scope of the claims, the summary below describes some of the advantageous features. The present disclosure provides innovative fire resistant building materials in various forms including fire resistant building panels.

In certain embodiments, a fiber cement fire resistant building panel is provided. The fiber cement fire resistant building panel comprises: a first major face; a second major face; a fire resistant body; and a finishing layer. The fire resistant body comprises a binder which includes a calcareous material and a siliceous material, at least one additive, and at least one fiber material. The finishing layer is secured to either the first major face of the fire resistant building panel or the second major face of the fire resistant building panel. The fire resistant body is disposed between the first major face and the second major face. In one embodiment, the calcareous material in the binder comprises Portland cement, and the Portland cement can comprise 25-35 parts by weight of the total weight of the fire resistant body. In another embodiment, the siliceous material in the binder comprises ground silica, and the ground silica can comprises 40-60 parts by weight of the total weight of the fire resistant body. In yet another embodiment, the at least one additive of the fire resistant body comprises a density modifying additive in the form of an expanded mineral, and the expanded mineral can comprise 15-20 parts by weight and an air entrainment agent in the form of aluminum powder. In some implementations, the air entrainment agent can comprise 0.05-1 parts by weight of the total weight of fire resistant body. In yet another embodiment, the fiber material of the fire resistant body comprises cellulose fibers, and the cellulose fibers can comprise approximately 0.05 parts by weight of the total weight of the fire resistant body.

In some embodiments, the fiber cement fire resistant building panel comprises: a first major face configured for engaging with a building substrate; a second major face configured to form a cladding face; a finishing layer secured to at least one of the first major face of the fire resistant building panel and the second major face of the fire resistant building panel; and a fire resistant body comprising a binder, at least one additive, and at least one fiber material, wherein the binder comprising a calcareous material and a siliceous material. The fire resistant body can be disposed between the first major face and the second major face.

In some embodiments, the present disclosure provides a fire resistant building panel comprising: a first major face; a second major face; and a fire resistant body comprising a binder, at least one additive, and at least one fiber material, wherein the binder comprises a calcareous material and a siliceous material; and wherein the fire resistant body is disposed between the first major face and the second major face.

In one embodiment, the fire resistant building panel is suitable for use as a cladding panel, wherein the fire resistant building panel is securable and/or secured to a building substrate to form a non-structural external cladding face. In some embodiments, the building substrate is a building structural frame. Accordingly, one possible advantage of the present disclosure is that the fire resistant building panel provides fire resistance together with the physical and mechanical properties of a building cladding material.

In one embodiment, the first major face of the fire resistant building panel is configured for engaging with a building substrate. In a further embodiment, the second major face is configured to form the cladding face. In one embodiment, either one or other, or both of the first major face and second major face of the fire resistant building panel is integrally formed with the fire resistant body of the fire resistant building panel.

For the purposes of this specification, the term ‘comprise’ shall have an inclusive meaning. Thus it is understood that it should be taken to mean an inclusion of not only the listed components it directly references, but also non specified components.

Further aspects of the present disclosure will become apparent from the ensuing description which is given by way of example only.

In some embodiments, the fire resistant body has a thickness of greater than or equal to 15 mm (0.6 inch) and less than or equal to 60 mm (2.4 inch), wherein the thickness of the fire resistant body is the length of the fire resistant body extending between the first major face and the second major face. The fire resistant body has a thickness of at least 15 mm (0.6 inch) and no more than 60 mm (2.4 inch), wherein the thickness of the fire resistant body has the length of the fire resistant body extending between the first major face and the second major face. In alternate embodiments, the fire resistant body has a thickness of greater than or equal to 25 mm (1 inch) and less than or equal to 50 mm (2 inch) or alternatively approximately 40 mm (1.6 inch). One advantage of the present disclosure is that the fire resistant building body is sufficiently thick to provide fire resistance but allows for ease of installation and handleability. When the fire resistant body comprises a thickness of above 60 mm (2.4 inch), the ease of handleability and ease of installation begins to be compromised without a significant increase in fire resistance.

In one embodiment, the fire resistant body further comprises a finishing layer, wherein the finishing layer is secured to either the first major face of the fire resistant building panel or the second major face of the fire resistant building panel. In an alternate embodiment, a finishing layer is secured to each of the first major face of the fire resistant building panel and the second major face of the fire resistant building panel.

In one embodiment, the finishing layer comprises a first face and a second face, wherein the first face is configured for engaging with a building substrate and the second face is configured for providing a suitable surface for securing the finishing layer to the second major face of the fire resistant body. In an alternate embodiment, the first face of the finishing layer is configured for providing a cladding face and the second face is configured for providing a suitable surface for securing the finishing layer to the first major face of the fire resistant body. In some embodiments, the finishing layer comprises one or more layers.

It is advantageous for the finishing layer to be formed from a material that is physically and chemically compatible with a fire rated body. Accordingly, in one embodiment, the finishing layer comprises a fiber cement layer. In alternative embodiments, the finishing layer can be formed from any suitable exterior durable cladding material. One possible additional advantage of the present disclosure is that the finishing layer or layer(s) provides protection for the fire resistant body, particularly during transportation from manufacture to the install site and/or during installation. The finishing layer also provides additional support when the fire resistant building panel is being secured to a building substrate or the like.

In some embodiments, the finishing layer comprises a thickness greater than or equal to 3 mm (0.12 inch) and less than or equal to 8 mm (0.32 inch), wherein the thickness of the finishing layer is the length of the finishing layer extending between the first face and the second face of the finishing layer. In alternate embodiments, the finishing layer comprises a thickness greater than or equal to 4 mm (0.16 inch) and less than or equal to 6 mm (0.24 inch).

Consequently, in the embodiments of the disclosure, when one or more finishing layers are applied to a fire resistant body, the combined thickness of the fire resistant body and one or more finishing layers ranges between 18 mm (0.7 inch) and 76 mm (3 inch).

In one embodiment, the calcareous material comprises hydrated lime or a cementitious material, such as, for example Portland cement. In certain embodiments, the calcareous material in the formulation for the fire resistant body is hydrated lime, wherein hydrated lime comprises between approximately 35 and 40 parts by weight of the total weight of the composition for the fire resistant body. In an alternative embodiment, the calcareous material in the formulation for the fire resistant body is Portland cement, wherein Portland cement comprises between approximately 10 and 35 parts by weight of the total weight of the composition for the fire resistant body.

In one embodiment, the reactivity of the siliceous material may be enhanced by using a fine particle size siliceous material, such as for example, micro-silica or silica fume. In certain embodiments, the siliceous material in the formulation for the fire resistant body comprises between approximately 5 and 60 parts by weight of the total weight of the composition for the fire resistant body.

In one embodiment, the binder is a reaction product of a reaction between the calcareous material and the siliceous material in the presence of water. In other embodiments, the binder comprises a geopolymer, wherein the geopolymer is a reaction product of the reaction between the calcareous material and the siliceous material. A geopolymer can be an inorganic material exhibiting a long-range, covalently bonded, non-crystalline network of atoms. Because geopolymer binders are condensed long-chain structures, there is little to no chemically bound water generated through heating above 100 degrees Celsius (212 degrees Fahrenheit).

In one embodiment, the at least one additive in the formulation for the fire resistant body is a density modifying additive. In some embodiments the density modifying additive comprises one or more of the group comprising expanded minerals, hollow microspheres and voids. In certain embodiments, the density modifying additive comprises between approximately 15 and 35 parts by weight of the total weight of the composition for the fire resistant body.

Examples of suitable expanded minerals are expanded vermiculite, expanded perlite, expanded mica and expanded clays. One advantage of expanded minerals is that, as most of the chemically bound water is driven off during the expansion, the expanded residue is relatively resistant to the high temperatures experienced during a fire exposure event. In some embodiments, the at least one density modifying additive is distributed homogeneously within the fire resistant body. In other embodiments, the density modifying additive is distributed preferentially within the fire resistant body.

In one embodiment, wherein the density modifying additive comprises hollow microspheres, the hollow microspheres could be naturally generated hollow microspheres such as those generated in the waste stream of coal fired power stations, for example, fly ash. Alternatively, the hollow microspheres could be synthetic microspheres or commercially available microspheres. Synthetic microspheres are formed deliberately through blending of raw materials to form a precursor, generally either a glass melt that is ground to fine particles, or a solution that is spray-dried to form fine particles. The precursor particles are then expanded at temperatures generally over 800 degrees Celsius (1472 degrees Fahrenheit) to form hollow microspheres. Examples of commercially available microspheres are Celite, Micro-Cel A and Micro-Cel E. The hollow microspheres, having been formed at high temperatures, are generally more resistant to the temperatures incurred during a fire resistance test than are materials that have not been exposed to such temperatures during formation. In certain embodiments, the hollow microspheres have a density less than or equal to 1 gm/cc (62.4 lb/ft3).

In certain embodiments, wherein the density modifying additive comprises voids, the density modifying additive is in the form of an air entraining agent or an alternative agent which generates gas bubbles due to a chemical reaction. The air entrainment agent creates air bubbles during the process for making for the fire resistant body which survive the mixing and curing process such that the formed fire resistant building panel has a plurality of voids dispersed throughout the fire resistant body. In some embodiment the voids may be discrete voids or alternatively form a continuous network of voids. In some embodiments, the air entraining agent comprises between approximately 0.05 and 1 parts by weight of the total weight of the composition for the fire resistant body.

In one embodiment, the air entraining agent comprises a reactive metal powder such as aluminum and/or zinc powder which is added to the binder of the fire resistant body. The binder of the fire resistant body comprises an alkali environment. When the reactive metal powder is exposed to the alkali environment the resulting reaction generates hydrogen gas as bubbles, which result in discrete gas filled voids in the fire resistant body. When the at least one density modifying additive is mixed into the composition of the fire resistant body during formation, any entrained air or voids, should generally be distributed evenly throughout the fire resistant body. Even distribution of the voids provides homogeneous performance in the final product. Voids may be also be entrained in the fire resistant body during mixing of precursor materials under high speed mixing conditions.

In a further embodiment, the performance of the fire resistant building panel can be tailored to provide optimized functional effectiveness in different portions of the fire resistant body by having the at least one density modifying additive distributed preferentially. For example, having a density gradient through the thickness of the fire resistant body, the body can provide a dense portion which provides the best weather resistance for an exterior building panel face, and a density modified portion where weather resistance is not a criteria. This is particularly the case when no additional layer is used, and the second major face of the fire resistant body provides an exterior durable surface of the fire resistant building panel.

In one embodiment, the at least one additive further comprises at least one filler. The at least one filler is selected from natural and/or synthetic carbonate compounds. Suitable carbonate compounds include for example, calcium carbonate, magnesium carbonate, and calcium magnesium carbonate. Carbonate minerals have the advantage that they are more environmentally stable at generally higher temperatures than the corresponding hydroxide or sulfate minerals. For example, calcium hydroxide is a reactive chemical which requires care during handling to avoid chemical burns to skin, etc. Heating calcium hydroxide results in thermal decomposition at 580 degrees Celsius (1076 degrees Fahrenheit), whereas calcium carbonate does not decompose until close to 900 degrees Celsius (1652 degrees Fahrenheit). In certain embodiments, wherein the at least one additive comprises at least one low density material and at least one filler, the at least one additive comprises between approximately 20 and 70 parts by weight of the total weight of the composition for the fire resistant body, wherein the ratio of the at least one low density material to the at least one filler is variable and is adjusted to maintain the density of the fire resistant building panel at between 0.40 gm/cc (25 lb/ft3) and 0.50 gm/cc (31.2 lb/ft3).

In one embodiment, the at least one fiber material is selected from at least one of the group comprising natural organic fibers, synthetic organic fibers, and synthetic inorganic fibers. One example of a suitable natural organic fiber is cellulose fiber. Cellulose fibers can be derived from wood, vegetables, or agricultural sources. Cellulose fibers can also be derived from either new and/or recycled wood which can be sourced from soft wood or hardwood trees or other plant based fibers include hemp, cotton, linen, and the like. Agricultural products such as straw, wheat straw and the like are also suitable. One example of an inorganic fiber is basalt fibers. Basalt fibers provide an inorganic fiber that has good heat resistant properties. The fiber is not present in sufficient quantity to act as a reinforcing fiber and is present predominantly to act as a processing aid during formation of the fire resistant body. In certain embodiments, the at least one fiber material in the formulation for the fire resistant body comprises between approximately 3 and 10 parts by weight of the total weight of the composition for the fire resistant body. In certain embodiments, the at least one fiber material comprises a mixture of cellulose fibers and basalt fibers, wherein the cellulose fibers and basalt fibers are provided in a ratio of approximately 2:1.

In one embodiment, the calcareous material in the formulation for the fire resistant body comprises hydrated lime, wherein hydrated lime comprises 35-40 parts by weight of the total weight of the composition for the fire resistant body; the siliceous material in the formulation for the fire resistant body comprises micro silica, wherein the micro silica comprises 20-30 parts by weight of the total weight of the composition for the fire resistant body; the at least one additive in the formulation for the fire resistant body comprises a density modifying additive in the form of an expanded mineral, wherein the expanded mineral comprises 30-35 parts by weight; and the at least one fiber material in the formulation for the fire resistant body comprises a mixture of cellulose fibers and basalt fibers, wherein the cellulose fibers and basalt fibers are provided in a ratio of approximately 2:1 and comprise between approximately 3 and 10 parts by weight of the total weight of the composition for the fire resistant body. Each of the components of the formulation for the fire resistant body are provided as dry components wherein the dry components total approximately 100 parts by weight.

In a further embodiment, the calcareous material in the formulation for the fire resistant body comprises Portland cement, wherein Portland cement comprises 10-20 parts by weight of the total weight of the composition for the fire resistant body; the siliceous material in the formulation for the fire resistant body comprises micro silica, wherein the micro silica comprises 5-15 parts by weight of the total weight of the composition for the fire resistant body; the at least one additive in the formulation for the fire resistant body comprises a density modifying additive and a filler, wherein the density modifying additive is in the form of microspheres having a density of less than 1 gm/cc (62.4 lb/ft3) and the filler is in the form of anhydrous calcium magnesium carbonate mineral, wherein the ratio of the first and second additive is such that the density of the fire resistant body is between approximately 0.40-0.50 gm/cc (25-31.2 lb/ft3) and wherein the at least one additive in the formulation comprises 20-70 parts by weight; and the at least one fiber material in the formulation for the fire resistant body comprises a mixture of cellulose fibers and basalt fibers, wherein the cellulose fibers and basalt fibers are provided in a ratio of approximately 2:1 and comprise between approximately 3 and 10 parts by weight of the total weight of the composition for the fire resistant body. Each of the components of the formulation for the fire resistant body are provided as dry components wherein the dry components total approximately 100 parts by weight.

In an alternative further embodiment, the calcareous material in the formulation for the fire resistant body comprises Portland cement, wherein Portland cement comprises 25-35 parts by weight of the total weight of the composition for the fire resistant body; the siliceous material in the formulation for the fire resistant body comprises ground silica, wherein the ground silica comprises 40-60 parts by weight of the total weight of the composition for the fire resistant body; the at least one additive in the formulation for the fire resistant body comprises a density modifying additive in the form of an expanded mineral, wherein the expanded mineral comprises 15-20 parts by weight and an air entrainment agent in the form of aluminum powder, wherein the air entrainment agent comprises 0.05-1 parts by weight of the total weight of the composition for the fire resistant body; and the at least one fiber material in the formulation for the fire resistant body comprise cellulose fibers, wherein the cellulose fibers comprise approximately 0.05 parts by weight of the total weight of the composition for the fire resistant body. Each of the components of the formulation for the fire resistant body are provided as dry components wherein the dry components total approximately 100 parts by weight.

In one embodiment, the fire resistant building body has a density of between approximately 0.35 and 0.50 gm/cc (21.8 and 31.2 lb/ft3). In an alternative embodiment, the fire resistant body has a density of between approximately 0.40 and 0.50 gm/cc (25 and 31.2 lb/ft3).

In one embodiment, the fire resistant building panel is configured such that the mass of panel does not exceed 30 kilograms per square meter (712 lb/ft2). In a further embodiment, the fire resistant building panel is configured such that the mass of panel does not exceed 25 kilograms per square meter (593 lb/ft2). One advantage of the present disclosure is that the configuration of the fire resistant building body is such that it provides fire resistance and is sufficiently light weight that it allows for ease of handling and installation.

According to one embodiment, the fire resistant body provides a fire rating of at least 45 minutes as tested in accordance with Australian Standard AS1530.4-2005, the disclosure of which is incorporated herein by reference in its entirety.

The present disclosure also provides a method of making a fire resistant body for a fire resistant building panel comprising the steps of: (a) placing a frame on a support surface to define the boundaries of the fire resistant body; (b) mixing a binder, wherein the binder comprises a calcareous material and a siliceous material; at least one additive; and at least one fiber material together with water to form a slurry; (c) introducing the slurry into the frame until the slurry has reached a required depth; (d) allowing the slurry to sit for an initial period of time to allow the slurry to partially cure; (e) removing the frame; and (f) allowing the partially cured slurry to fully cure to form the fire resistant body of the fire resistant building panel.

The present disclosure also provides a method of making a fire resistant building panel comprising the steps of: (a) providing a finishing layer of suitable dimensions; (b) placing a frame on the finishing layer to define the boundaries of a fire resistant body; (c) mixing a binder, wherein the binder comprises a calcareous material and a siliceous material; at least one additive; and at least one fiber material together with water to form a slurry; (d) introducing the slurry onto the finishing layer in the frame until the slurry has reached a required depth; (e) allowing the slurry to sit for an initial period of time to allow the slurry to form a partially cured fire resistant body; (f) removing frame; (g) optionally applying a second finishing layer to the partially cured fire resistant body; and (h) allowing the partially cured slurry to fully cure.

The present disclosure also provides a method of making a fire resistant building panel comprising the steps of: (a) providing a finishing layer of suitable dimensions; (b) placing a frame on the finishing layer to define boundaries of a fire resistant body; (c) mixing a binder, wherein the binder comprises a calcareous material and a siliceous material, at least one additive, and at least one fiber material together with water to form a slurry; (d) introducing the slurry onto the finishing layer in the frame until the slurry has reached a required depth; (e) allowing the slurry to sit for an initial period of time to allow the slurry to form a partially cured fire resistant body; (f) removing the frame; and (g) allowing the partially cured slurry to fully cure. The method can further comprise applying a second finishing layer to the partially cured fire resistant body after the removing of the frame and before allowing the partially cured slurry to fully cure.

According to one embodiment, the finishing layer is an uncured (green sheet) fiber cement layer. In such an embodiment, the slurry is introduced at step (d) of the method onto an uncured fiber cement finishing layer and optionally at step (g) of the method an uncured fiber cement finishing layer is applied as the second finishing layer to the partially cured slurry. In such an instance the slurry and uncured fiber cement finishing layer or layers are then co-cured to form an integrally formed fire resistant building panel.

In this way, there are no adhesives used to bond fire resistant body to second major surface of first finishing layer, and the fire resistance of fire resistant building panel is not compromised by any premature adhesive failure. In an embodiment, where the finishing layer is an uncured (green sheet) fiber cement layer, then some form of temporary auxiliary support may also be required to prevent the uncured fiber cement layer deforming during formation of fire resistant building panel. This may be particularly so if the fire resistant building panel is formed by casting in a vertical orientation. Once initial set of the slurry has occurred, the temporary auxiliary support can be removed.

It is to be understood that the foregoing summary is illustrative only and is not intended to be in any way limiting. In addition to the illustrative aspects, embodiments and features described above, further aspects, embodiments and features will become apparent by reference to the drawings and following detailed description

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIG. 1 shows a cross-sectional side view of a fire resistant building panel according to one embodiment of the present disclosure, including an expanded schematic view of the composition of the fire resistant body (not to scale).

FIG. 2 shows a cross-sectional side view of a fire resistant building panel according to one embodiment of the present disclosure.

FIG. 3 shows a cross-sectional side view of a fire resistant building panel according to one embodiment of the present disclosure.

FIG. 4 shows a cross-sectional side view of a fire resistance test panel construction suitable for use in testing a fire resistant building panel produced according to one embodiment of the present disclosure;

FIG. 5 is a graph of fire resistance test results of a fire resistant building panel produced according to one embodiment of the present disclosure.

FIG. 6 is a graph of fire resistance test results of a fire resistant building panel produced according to one embodiment of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be used, and other changes may be made, without departing from the spirit or scope of the subject matter presented here. It will be readily understood that the embodiments of the present disclosure, as generally described herein, and illustrated in the figures, can be arranged, substituted, combined, and designed in a wide variety of different configurations, all of which are explicitly contemplated and made part of this disclosure. The drawing figures are not necessarily to scale and certain features may be shown exaggerated in scale or in somewhat generalized or schematic form in the interest of clarity and conciseness.

Although the present disclosure is described with reference to specific examples, it will be appreciated by those skilled in the art that the present disclosure may be embodied in many other forms. The embodiments discussed herein are merely illustrative and do not limit the scope of the present disclosure.

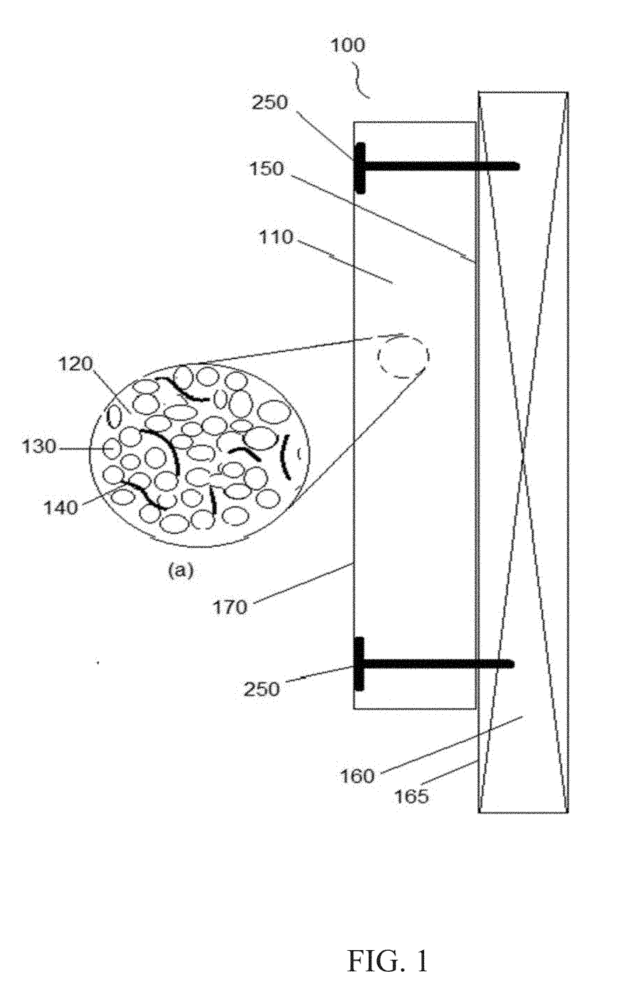

Referring now to the drawings, FIG. 1 shows an example embodiment of a fire resistant building panel 100 comprising a fire resistant body 110 having a first major face 150 for engaging with building substrate 160, and a second major face 170 for providing an exposed cladding face remote from the building substrate 160. In the example embodiment shown, fire resistant building panel 100 is shown face fixed to one surface 165 of building substrate 160 using suitable mechanical fixings, for example, nails 250. It is understood that in this embodiment and in other example embodiments that other suitable mechanical and/or chemical fixings could also be used to attach fire resistant building panel 100 to building substrate 160.

As will be discussed in greater detail below, FIG. 1 shows an enlarged schematic of the composition of the example embodiment fire resistant body 110. The components shown in FIG. 1 are not drawn to scale and should be taken as a general representation of the arrangement of materials, according to the example embodiment of the present disclosure, and not an accurate or exact drawing of a material. Fire resistant building panel 100 can comprise a binder 120 comprising a calcareous material and a siliceous material, at least one additive 130, and/or at least one fiber 140. One advantage of certain embodiments of the fire resistant building panel 100, is that the composition of the fire resistant building panel 100 provides fire resistance together with the physical and mechanical properties normally associated with a building cladding material.

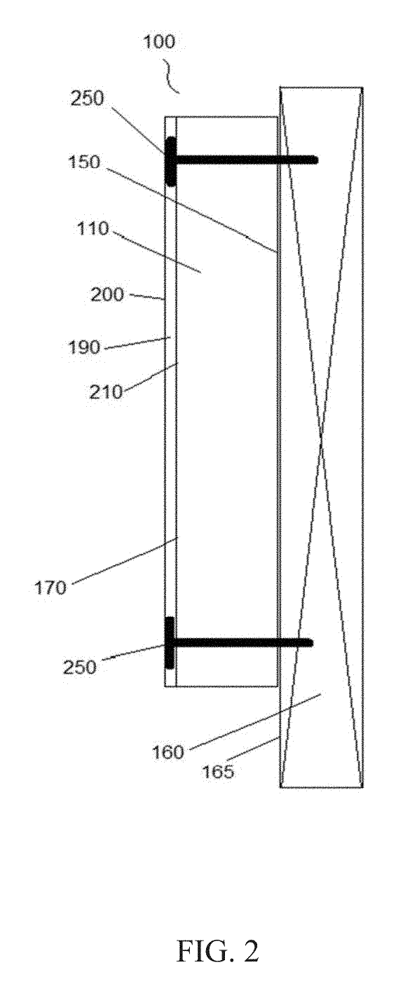

In an alternative exemplary embodiment of fire resistant building panel 100, as best shown in FIG. 2, fire resistant body 110 further comprises finishing layer 190 secured to surface 210 of fire resistant body 110 to form second major face 170. In the embodiment shown, surface 210 of fire resistant body 110 is remote or not adjacent or proximate to first major face 150. First major surface 200 of finishing layer 190 can be configured for providing a cladding face. In the exemplary embodiment shown, finishing layer 190 can have a thickness of between approximately 3 mm and 8 mm. It is also possible for finishing layer 190 to have a thickness of between approximately 4 mm and 6 mm. It is advantageous for finishing layer 190 to be formed from a material that is physically and chemically compatible with fire rated body 110. Accordingly, in one embodiment, finishing layer 190 can be formed from fiber cement. In alternative embodiments, finishing layer 190 can be formed from any suitable exterior durable cladding material.

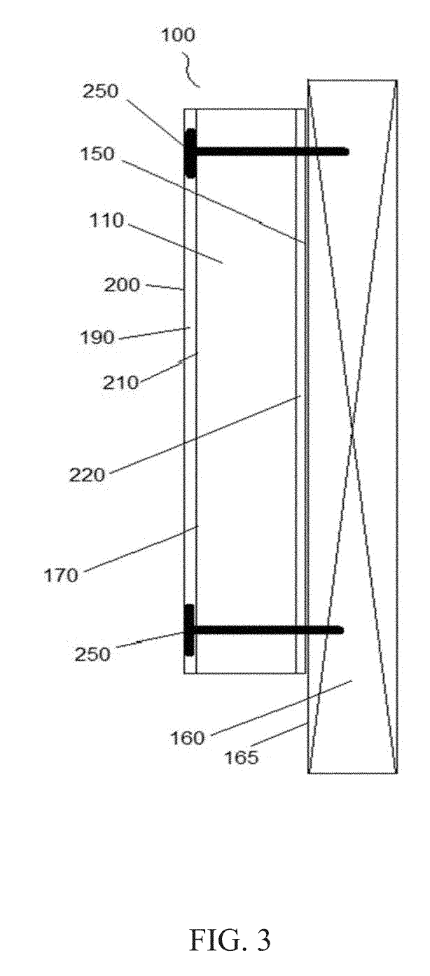

In a further alternative exemplary embodiment of fire resistant building panel 100, as best shown in FIG. 3, fire resistant body 110 can comprise separate finishing layers 190 and 220 secured to opposing faces of fire resistant body 110 to form the first major face 150 and second major face 170 of the fire resistant building panel 100. Similar to as that described above, first major surface 200 can be configured for providing a cladding face. In the exemplary embodiment shown, each of finishing layers 190 and/or 220 can have a thickness of between approximately 3 mm and 8 mm. In the embodiment shown, finishing layers 190 and 220 can be formed from fiber cement respectively. Alternatively, finishing layers 190 and 220 can be formed from non-fiber cement, and can be formed of the same or different materials. In alternative embodiments, finishing layers 190 and 220 can be formed from any suitable exterior durable cladding material as previously described.

In each of the exemplary embodiments shown in FIGS. 2 and 3, finishing layer 190 may be formed from any suitable durable cladding material, but is preferably formed from a material that is physically and chemically compatible with fire rated body 110. In the exemplary embodiments shown, finishing layer 190 is formed from fiber cement and can be suitably formulated for exposure during service as an interior or an exterior cladding material.

In one embodiment of the fire resistant building panel 100 of FIG. 2 or 3, wherein the fire resistant building panel 100 comprises either or both of finishing layers 190 and 220, finishing layers 190 and/or 220 can be secured to the fire resistant body 110 using either mechanical or chemical fixings and/o attachments.

In an alternative embodiment of fire resistant building panel 100, either or both of finishing layers 190 and 220 can comprise fiber cement finishing layers. The fiber cement finishing layers 190, 220 can be a cured or an uncured (green sheet) fiber cement layer. The advantage of using an uncured fiber cement finishing layer is that during the formation process the fire resistant body 110 and the uncured fiber cement finishing layer or layers can be co-cured to form fire resistant building panel in which the finishing layer(s) and fire resistant body can be integrally formed with each other.

In a further embodiment of the present disclosure, it is also possible to apply a coating to provide a functional and/or aesthetic finish onto the second major face of the fire resistant building panel.

### EXAMPLES

As will be discussed in greater detail below, in some embodiments of the present disclosure provided herein, the composition of fire resistant body 110 can be formed from a binder 120, at least one additive 130 and/or at least one fiber 140, wherein the binder can comprise a calcareous material and a siliceous material. Formation of fire resistant body 110 can be achieved by blending the components of the composition together with water to form a slurry and casting in a mold, frame or formwork.

In each of Examples 1 to 3 below, samples of compositions of a fire resistant building panel of the type exemplified in FIGS. 1, 2 and 3 above were formed. Sample 1 of each of examples 1 to 3 comprises a fire resistant body 110. Sample 2 of each of examples 1 to 3 comprises a fire resistant body 110 together with a finishing layer 190 secured to at least one face of the fire resistant body 110. Sample 3 of each of examples 1 to 3 comprises a fire resistant body 110 together with finishing layers 190 and 220 secured to opposing faces of the fire resistant body 110.

### Example 1. Hydrated Lime and Silica

TABLE 1
Example 1

| | Formulation Range/ | Specific Example/ |
|---|---|---|
| Component | parts by weight | parts by weight |
| Calcareous material | 35-40 | 37 |
| Siliceous Material | 20-30 | 23 |
| Additive | 30-35 | 32 |
| Fiber | 3-10 | 8 |

TABLE 1(a)
Density results

| | | |
|---|---|---|
| DENSITY (gm/cc) | 0.35-0.50 | 0.46 |

Sample 1: The calcareous material in the formulation for the fire resistant body of Example 1 is hydrated lime and the siliceous material is micro silica. The at least one additive in the formulation for the fire resistant body is a density modifying additive in the form of an expanded mineral, such as, for example, expanded perlite. The at least one fiber material in the formulation for the fire resistant body comprises a mixture of cellulose fibers and basalt fibers, wherein the cellulose fibers and basalt fibers are provided in a ratio of approximately 2:1. The cellulose fibers comprises one or more of softwood kraft cellulose pulp, hardwood pulp, straw derived and the like. Each of the components are provided as dry components in parts by weight as outlined in Table 1 wherein the dry components total approximately 100 parts by weight.

The dry components are mixed together with water to form a slurry using conventional mixing means. Approximately 30 to 50 parts by weight of water are added to the dry components to form a slurry of the desired consistency which depends on the forming method to be used. Separately a frame is positioned on a supporting substrate such that a seal is formed between the frame and the substrate. The slurry is then cast into the frame on top of the substrate until the slurry has reached a pre-determined depth of between approximately 15 mm (0.6 inch) and 60 mm (2.4 inch) within the frame structure. The slurry was then allowed to rest at ambient conditions for approximately 1 hour. The resting time is calculated to allow the slurry to partially cure such that it is possible to remove the frame structure without the partially cured slurry losing its shape. The partially cured slurry is then allowed to rest for a period of time in which it is allowed to complete curing. The time required to complete the curing process is variable. In the above exemplary embodiment, the partially cured slurry is allowed to rest for a period of 24 hours at ambient temperature to complete curing. In one embodiment, the fire resistant body of Example 1 is designed to be less than 60 mm thick (2.4 inch) and have a mass of less than 30 kg/square meter (712 lb/ft²). The density of the fire resistant body of Example 1 is between 0.35 and 0.5 gm/cc (21.8 and 31.2 lb/ft³) as outlined in Table 1(a).

In an alternate embodiment, the fire resistant building panels may be formed from the same formulation and forming method, but using steam curing or autoclave curing. For example, in one alternate embodiment, the fire resistant building panel may be cured at a minimum of 50 degrees Celsius (122 degrees Fahrenheit) for a minimum of 6 hours, or autoclave cured by heating in an autoclave to a temperature of 170 to 180 degrees Celsius (338 to 356 Fahrenheit).

Sample 2: In a second set of samples, a slurry is formed in accordance with the method and formulation of Example 1, sample 1 and Table 1. Separately a frame is positioned around an autoclaved 4.5 mm (0.2 inch) fiber cement layer. The slurry is then cast into the frame on top of the fiber cement layer until the slurry has reached a depth of approximately 40 mm (1.6 inch) within the frame structure. The slurry was then allowed to rest at ambient conditions for approximately 1 hour. The resting time is calculated to allow the curing reaction to proceed sufficiently so that the slurry is partially cured and that it is possible to remove the frame structure without the slurry losing its shape. After resting and allowing the slurry to partially cure, the frame was removed and the composite fire resistant building panel is allowed to sit and air cure for 24 hours at ambient temperature. The resultant fire resistant building panel is of the type exemplified in FIG. 2 above which comprises an integrally formed finishing layer 190 secured to fire resistant body 110 to form the second major face 170.

Sample 3: In a third set of samples, a slurry is formed in accordance with the method and formulation of Example 1, sample 1 and Table 1. Similarly to sample 2, a frame is positioned around an autoclaved 4.5 mm fiber cement layer. The slurry is then cast into the frame on top of the fiber cement layer until the slurry has reached a depth of approximately 40 mm within the frame structure. The slurry was then allowed to rest at ambient conditions for approximately 1 hour. The resting time is calculated to allow the slurry to partially cure such that it is possible to remove the frame structure without the slurry losing its shape. A second 4.5 mm (0.2 inch) fiber cement layer was applied to the surface of the slurry and the composite fire resistant building panel was allowed to sit and air cure for 24 hours at ambient temperature. The resultant fire resistant building panel is of the type exemplified in FIG. 3 above which comprises an integrally formed finishing layers 190 and 220 bonded to opposing faces of fire resistant body 110 to form the first major face 150 and second major face 170.

In alternate embodiments, the frame may be sized relatively smaller than a first layer, or positioned asymmetrically on the first layer to provide a formed edge profile such as complementary interlocking edge formations in the final formed fire resistant building panel.

### Example 2. Portland Cement

The compositions of Examples 2 and 3 are similar in that the calcareous material of the fire resistant body is a Portland cement based hydraulic binder system. The compositions of Example 3 provide an alternative to the compositions of Example 2. In Example 2, a low density additive is a component added to the formulation. In contrast, in Example 3, density modification takes the form of an in-situ chemical reaction caused by the presence of an air entrainment agent. Representative formulation ranges and specific formulations for each of Examples 2 and 3 are shown in Tables 2 and 3 respectively below.

TABLE 2
Example 2

| | Formulation Range/ | Specific Example/ |
|---|---|---|
| Component | parts by weight | parts by weight |
| Calcareous Material | 10-20 | 17 |
| Siliceous material | 5-15 | 10 |
| Additive | 20-70 | 65 |
| Fiber | 3-10 | 8 |

TABLE 2(a)
Density results

| | | |
|---|---|---|
| DENSITY (gm/cc) | 0.40-0.50 | 0.48 |

Sample 1: In sample 1 of Example 2, the calcareous material in the formulation for the fire resistant body is ordinary Portland cement and the siliceous material is micro silica. The at least one additive in the formulation for the fire resistant body comprises a density modifying additive and a filler. The density modifying additive is in the form of microspheres having a density of less than 1 gm/cc (62.4 lb/ft3). The filler is in the form of anhydrous calcium magnesium carbonate mineral. The ratio of the first and second additive is variable and is adjusted in order to maintain the density of the fire resistant body so that it is within the desired density range of 0.40-0.50 gm/cc (25-31.2 lb/ft3).

The at least one fiber material in the formulation for the fire resistant body comprises a mixture of cellulose fibers and basalt fibers, wherein the cellulose fibers and basalt fibers are provided in a ratio of approximately 2:1. The cellulose fibers comprise softwood kraft cellulose pulp. Each of the component are provided as dry components and are mixed with water to form a slurry. Each of the component are provided as dry components in parts by weight as outlined in Table 2 wherein the dry components total approximately 100 parts by weight. Approximately 30 to 50 parts by weight of water are mixed with the dry components to form a slurry of desired consistency which depends on the forming method to be used.

As before, the slurry of Example 2 is then cast into a frame on top of a substrate until the slurry has reached a pre-determined depth of between approximately 15 mm and 60 mm within the frame structure. The slurry was then allowed to rest at ambient conditions for approximately 1 hour. The resting time is calculated to allow the slurry to partially cure such that it is possible to remove the frame structure without the partially cured slurry losing its shape. The partially cured slurry is then allowed to rest for a period of time in which it is allowed to complete curing. The time required to complete the curing process is variable. In the above exemplary embodiment, the partially cured slurry is allowed to rest for a period of 24 hours at ambient temperature to complete curing. In one embodiment, the fire resistant body of Example 2 is designed to have a density between 0.4 and 0.5 gm/cc (25 and 31.2 lb/ft3) as outlined in Table 2(a).

As per Example 1, it is also possible to have alternate embodiments in which the fire resistant building panels may be formed from the same formulation and forming method, as outlined for Example 2 above, but using steam curing or autoclave curing. For example, in one alternate embodiment, the fire resistant building panel may be cured at a minimum of 50 degrees Celsius (122 degrees Fahrenheit) for a minimum of 6 hours, or autoclave cured by heating in an autoclave to a temperature of 170 to 180 degrees Celsius (338 to 356 Fahrenheit).

Sample 2: In a second set of samples, a slurry is formed in accordance with the method and formulation of Example 2, sample 1 and Table 2.

An uncured (green sheet) fiber cement layer is formed by mixing a fiber cement slurry with approximate ratios of cement to silica to cellulose pulp, wherein the ratio of cement to silica to cellulose pulp is 1:1:0.15. The fiber cement slurry is then formed into a green-sheet using a Hatschek machine or dewatered in a filter press or similar to form the uncured fiber cement having a thickness of approximately 4 to 5 mm (0.16 to 0.20 inch).

Separately a frame is positioned around the uncured (green sheet) fiber cement layer. The slurry of Example 2, sample 1 was cast into the frame on top of the fiber cement layer until the slurry reached a desired depth within the frame structure. The slurry was then allowed to rest at ambient conditions until such a time as the slurry is partially cured and it was possible to remove the frame structure without the slurry losing its shape. The frame was then removed from a composite panel comprising the partially cured green sheet fiber cement layer and the partially cured fire resistant body. The composite panel was then cured in an autoclave under normal conditions. The fiber cement green sheet and the fire resistant body react during curing to provide an integrally formed composite fire resistant building panel. The resultant fire resistant building panel is of the type exemplified in FIG. 2 above which comprises an integrally formed finishing layer 190 secured to fire resistant body 110 to form the second major face 170.

Sample 3: In a third set of samples, a slurry is formed in accordance with the method and formulation of Example 2, sample 1 and Table 2.

Similarly to Example 2, sample 2, an uncured (green sheet) fiber cement layer is formed by mixing a fiber cement slurry with approximate ratios of cement to silica to cellulose pulp, wherein the ratio of cement to silica to cellulose pulp is 1:1:0.15. The fiber cement slurry is then formed into a green-sheet using a Hatschek machine or dewatered in a filter press or similar to form the uncured fiber cement having a thickness of approximately 4 to 5 mm (0.16 to 0.20 inch).

A frame was positioned around the uncured (green sheet) fiber cement layer. The slurry of Example 2, sample 1 was cast into the frame on top of the fiber cement layer until the slurry reached a desired depth within the frame structure. The slurry was then allowed to rest at ambient conditions until such a time as the slurry is partially cured and it was possible to remove the frame structure without the slurry losing its shape. The frame was then removed from a composite panel comprising the partially cured green sheet fiber cement layer and the partially cured fire resistant body. A second 4.5 mm (0.18 inch) fiber cement layer was applied to the surface of the partially cured slurry. Pressure was applied to bring the second fiber cement layer into direct contact with the partially cured slurry to form the composite fire resistant building panel. The composite fire resistant building panel is allowed to sit and air cure for 24 hours at ambient temperature.

The resultant fire resistant building panel is of the type exemplified in FIG. 3 above which comprises an integrally formed finishing layer 190 and 220 bonded to opposing faces of fire resistant body 110 to form the first major face 150 and second major face 170.

### Example 3. Portland Cement and Aluminum Powder

TABLE 3
Example 3

| | Formulation Range/ | Specific Example/ |
|---|---|---|
| Component | parts by weight | parts by weight |
| Calcareous Material | 25-35 | 32 |
| Siliceous Material | 40-60 | 47.9 |
| 1^{st} Additive | 15-20 | 20 |
| 2^{nd} Additive | 0.05-1 | 0.05 |
| Fiber | 0.05 | 0.05 |

Sample 1: In example 3, the formulation for the fire resistant body comprises a calcareous material in the form of Portland cement and a siliceous material in the form of ground silica. The at least one additive in the formulation for the fire resistant body comprises a first additive and a second additive. The first additive is a density modifying additive in the form of an expanded mineral, such as expanded perlite. The second additive comprises an air entrainment agent in the form of aluminum powder. The at least one fiber material in the formulation for the fire resistant body comprises cellulose fibers. The cellulose fibers comprise softwood kraft cellulose pulp. Each of the component are provided as dry components and are mixed with water to form a slurry. The dry components total approximately 100 parts by weight and are mixed with water in an approximate 2:1 ratio to form the slurry.

The slurry is then cast into a frame until the slurry has reached a pre-determined depth of between approximately 15 mm and 60 mm within the frame structure. The frame is provided with a temporary support substrate to support the slurry until it is partially cured. In one embodiment the temporary support substrate could be in the form of a releasable base plate. When the slurry composition is poured into frame, expansion of the slurry as a result of the chemical reaction of Portland cement binder 120 and aluminum powder in which resulting gas voids are formed throughout the fire resistant body 110 is visible. The slurry is allowed to rest at ambient conditions for approximately 1 hour until the slurry is partially cured and it is possible to remove the frame structure without the partially cured slurry losing its shape. The partially cured slurry is then allowed to rest for a period of time in which it is allowed to complete curing. The time required to complete the curing process is variable. In the above exemplary embodiment, the partially cured slurry is allowed to rest for a period of 24 hours at ambient temperature to complete curing. In an alternate embodiment, the fire resistant building panels may be formed from the same formulation, and forming method, but using steam curing or autoclave curing. For example, in one alternate embodiment, the fire resistant building panel may be cured at a minimum of 50 degrees Celsius (122 degrees Fahrenheit) for a minimum of 6 hours, or autoclave cured by heating in an autoclave to a temperature of 170 to 180 degrees Celsius (338 to 356 Fahrenheit).

### Sample 2:

TABLE 3(a)
Example 3: Fire Resistant finishing layer

| | Formulation Range/ | Specific Example/ |
|---|---|---|
| Component | parts by weight | parts by weight |
| Calcareous Material | 25-35 | 35 |
| Siliceous Material | 40-60 | 45 |
| 1^{st} Additive | 5-10 | 10 |
| 2^{nd} Additive | 3-5 | 3 |
| Fiber | 5-10 | 7 |

In a second set of samples, a slurry is formed in accordance with the method and formulation of Example 3, sample 1 and Table 3. Separately, a fiber cement layer is formed using a Hatschek machine or a filter press. The formulation for the fiber cement layer comprises a calcareous material comprising Portland cement, a siliceous material comprising ground silica, a first additive comprising calcium carbonate, a second additive comprising hydrated alumina and at least one fiber comprising cellulose pulp. The dry components are mixed in the amounts outlined in Table 3(a) with water in an approximate 2:1 ratio to form a slurry. In this example, the slurry was then formed into an uncured (green sheet) fiber cement layer using either a Hatschek machine or a filter press. In one embodiment, the uncured (green sheet) fiber cement layer is used as a first finishing layer 190 to form a composite fire resistant building panel. In an alternate embodiment, the fiber cement green sheet may be cured by air curing, steam curing or autoclave curing to form a cured fiber cement sheet prior to being used to provide first finishing layer.

As for the previous examples, a frame is provided on the first finishing layer. The slurry composition for fire resistant body is poured into frame onto the first finishing layer. When the slurry composition is poured into frame, expansion of the slurry as a result of the chemical reaction of Portland cement binder and aluminum powder in which resulting gas voids are formed throughout the fire resistant body is visible. The fire resistant body is allowed to cure as previously described.

Sample 3: In a third set of samples, a second finishing layer is applied to the second major face of the fire resistant body of Example 3, sample 2. The second finishing layer is also an uncured (green sheet) or cured fiber cement layer of the kind described in Example 3, Sample 2. In one exemplary embodiment, the second finishing layer is restrained in position, such that the expansion of fire resistant body between first layer and second layer and frame is constrained. Consequently voids formed near each of the first and second major faces adjacent the respective finishing layers, and/or at the edges of the frame structure, will collapse and leave a densified area in these portions relative to other areas of the fire resistant body. The result of the constraint will be that voids will be preferentially distributed in fire resistant body.

In an alternate embodiment of Example 3, sample 1 or sample 2, it is also possible to constrain expansion of the slurry as a result of the chemical reaction of Portland cement binder 120 and aluminum powder using releasable base plates with the frame structure. The releasable base plates will constrain the expansion of the slurry in a similar way to that of the finishing layers such that voids formed near each of the releasable base plates, and/or at the edges of the frame structure, will collapse and leave a densified area in these portions relative to other areas of the fire resistant body. Densification of the fire resistant body at either one or other, or both, of the first major face and second major face is beneficial in providing an integrally formed weather durable cladding face on fire resistant body.

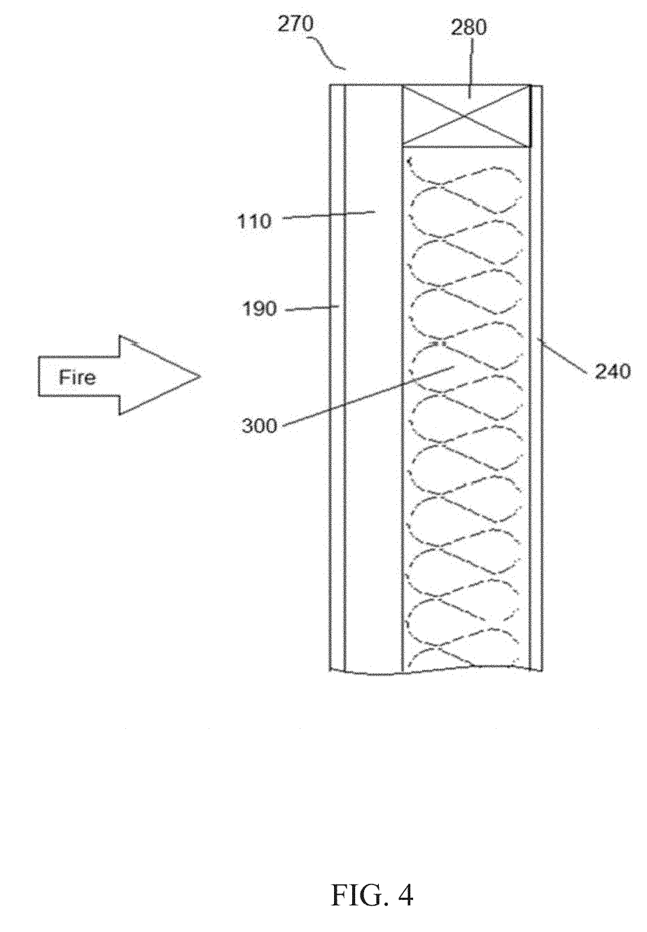

Fire resistance tests were conducted for a range of different panel thicknesses manufactured using the formulations of Examples 1 to 3 as provided in tables 1 to 3 above. Comparisons were made with other commercially available materials tested under the same conditions. A fire test panel assembly was constructed using the fire resistant building panel according to any one Examples 1 to 3, to test the sample in accordance with Australian Standard AS1530.4-2005. A cross sectional side view of the fire test panel assembly 270, showing the direction from which the fire is applied by the furnace during the test is shown in FIG. 4.

The fire test requires making a building wall test section of approximately 1.2 meters high×1.2 meters wide (4 ft high×4 ft wide). The test section is constructed using a timber frame 280, where timber framing members are 90 mm×35 mm spaced at 60 mm centers (3.5 inch×1.4 inch spaced at 2.4 inch centers). The frame is clad on the side to be exposed to the fire with the fire resistant building panel and fixed to the frame at 200 mm (8 inch) centers. In the example shown in FIG. 4, a fire resistant panel in accordance with the exemplary embodiment of FIG. 2 comprising a fire resistant body 110 and first finishing layer 190 is attached to timber frame 280. The cavities in the frame, between framing members, are filled with insulating material 300 in the form of an R2.5 fibrous insulation batt. The rear face (non-fire side) is clad with a second cladding material 240, such as an interior lining board, for example a 6 mm fiber cement panel or a 16 mm plasterboard panel. Altogether, the test panel is approximately 120 mm (4.7 inch) thick. The test provides a rating in the form of a time. The time is the time required for the temperature measured on the rear face (non-fire side) panel to reach 140 degrees Celsius (284 degrees Fahrenheit) above ambient temperature. For example, a 2 hour fire rating means that it took 2 hours for the rear face of a test panel to reach ambient temperature+140 degrees Celsius (284 degrees Fahrenheit).

Fire resistance testing of current commercially available panels were carried out concurrently with fire resistant building panels made according to samples 1 of Examples 1 and 2 of the present disclosure. The results below in Table 4 provide a comparison of the Fire Ratings achieved by each.

TABLE 4
Fire Resistance Tests Results and Fire Ratings

| | | | Fire |
|---|---|---|---|
| | Thickness | Time to 140 deg C. above | Rating |
| Product | (mm) | ambient (minutes) | (minutes) |
| Plasterboard | 16 | 164 deg @ 30 | 28 |
| | 25 | 164 deg @ 50 | 48 |
| | 32 | 164 deg @ 97 | 95 |
| AAC | 16 | 164 deg @ 25 | 23 |
| | 25 | 164 deg @ 42 | 40 |
| Example 1, Sample 1 | 16 | 164 deg @ 52 | 50 |
| Example 2, Sample 1 | 16 | 164 deg @ 54 | 52 |
| Example 1, Sample 1 | 25 | 164 deg @ 78 | 75 |
| Example 2, Sample 1 | 28 | 164 deg @ 82 | 80 |
| Example 1, Sample 1 | 32 | 164 deg @ 119 | 118 |
| Example 2, Sample 1 | 35 | 164 deg @ 125 | 125 |
| Example 1, Sample 1 | 40 | 82 deg @ 119—test stopped | 142 |
| Example 2, Sample 1 | 40 | 82 deg @ 119—test stopped | 142 |

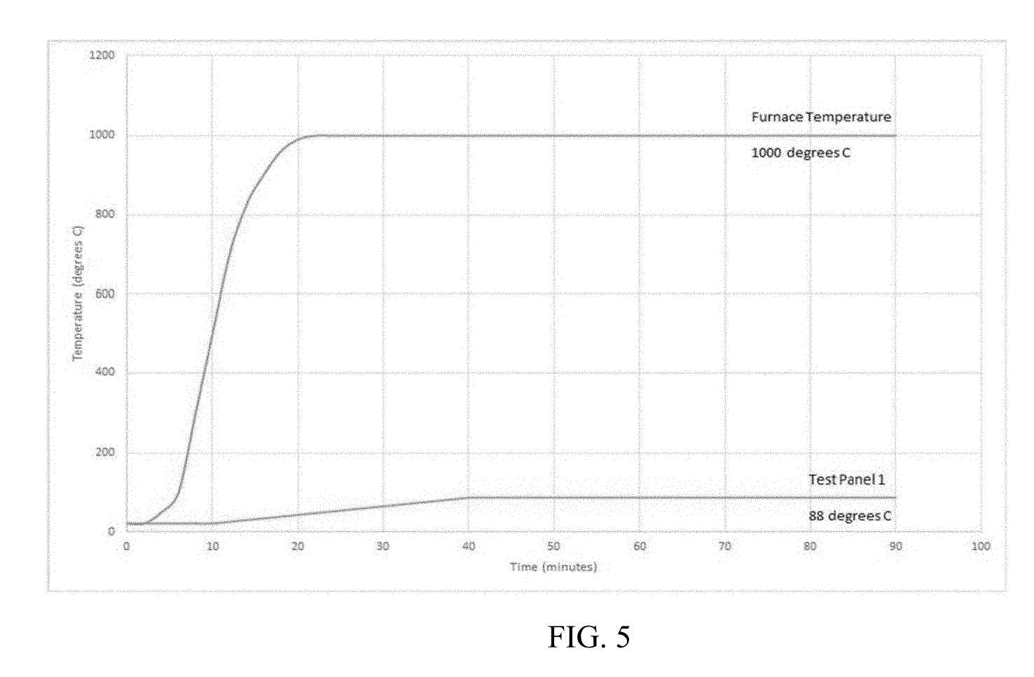

A trace of the Fire Rating test for a 40 mm (1.6 inch) fire resistant building panel manufactured using Example 1 is shown in FIG. 5, where the trace of the “fire” side temperature provided by the fire test furnace apparatus is shown reaching 1000 degrees Celsius (1832 degrees Fahrenheit) and holding until approximately 120 minutes. On the same trace, a temperature reading on the rear face of second cladding material 240 on the rear face of fire test panel assembly 270 is shown, reaching only 82 degrees Celsius (180 degrees Fahrenheit) after a test time of 119 minutes, after which the test was stopped.

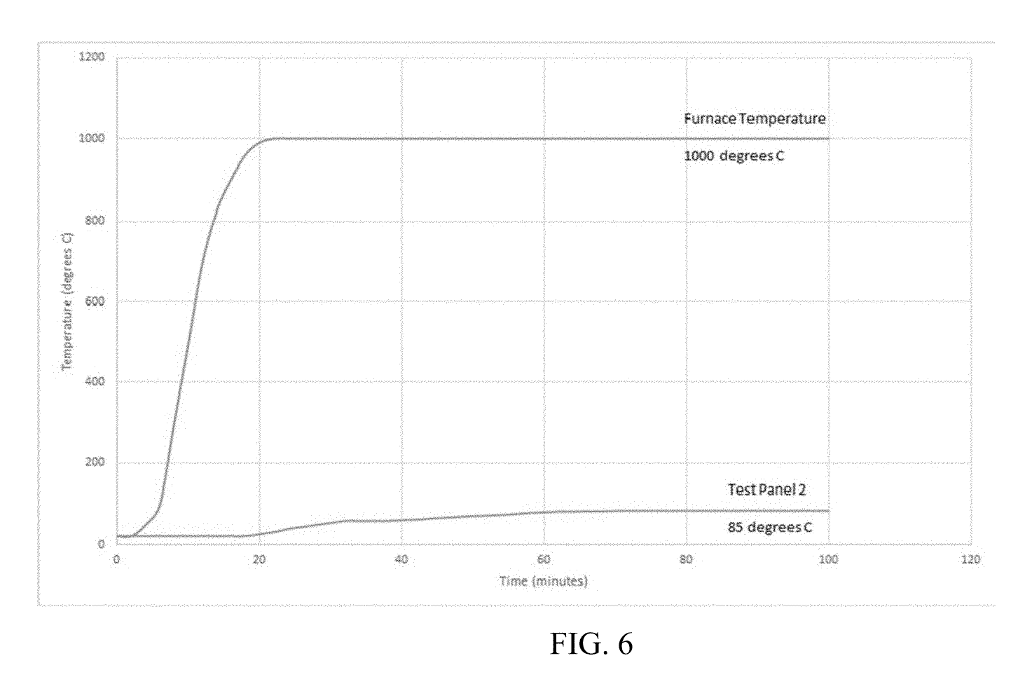

Similarly, a trace of Fire Rating test for a 40 mm thick fire resistant building panel manufactured using example 2 is shown in FIG. 6, showing the furnace temperature during the test, and the temperature measured on the rear face of fire resistant building panel assembly 270.

Fire resistance testing of current commercially available panels were carried out concurrently with fire resistant building panels made according to samples 2 of Examples 1 and 2 of the present disclosure. The results below in Table 5 provide a comparison of the Fire Ratings achieved by each. In the exemplary embodiments the finishing layer comprises a fiber cement layer having a thickness of approximately 4.5 mm (0.2 inch).

TABLE 5
Fire Resistance Tests Results and Fire Ratings

| | Thickness | Time to 140 deg C. above | Fire Rating |
|---|---|---|---|
| Product | (mm) | ambient (minutes) | (minutes) |
| Example 1, | 16 | 169 deg @ 52 | 55 |
| Sample 2 | 25 | 164 deg @ 83 | 80 |
| | 32 | 163 deg @ 119 | 121 |
| | 40 | 82 deg @ 123—test stopped | 147 |
| Example 2, | 16 | 168 deg @ 54 | 56 |
| Sample 2 | 28 | 164 deg @ 87 | 87 |
| | 35 | 164 deg @ 130 | 130 |
| | 40 | 82 deg @ 124—test stopped | 145 |

Fire resistance testing of current commercially available panels were carried out concurrently with fire resistant building panels made according to samples 3 of Examples 1 and 2 of the present disclosure. The results below in Table 6 provide a comparison of the Fire Ratings achieved by each. In the exemplary embodiments, each of the finishing layers comprise a fiber cement layer having a thickness of approximately 4.5 mm (0.2 inch).

TABLE 6
Fire Resistance Tests Results and Fire Ratings

| | Thickness | Time to 140 deg C. above | Fire Rating |
|---|---|---|---|
| Product | (mm) | ambient (minutes) | (minutes) |
| Example 1, | 16 | 164 deg @ 61 | 59 |
| Sample 3 | 25 | 164 deg @ 87 | 83 |
| | 32 | 164 deg @ 129 | 128 |
| | 40 | 82 deg @ 128 | 151 |
| Example 2, | 16 | 168 deg @ 63 | 61 |
| Sample 3 | 28 | 164 deg @ 92 | 90 |
| | 35 | 164 deg @ 135 | 135 |
| | 40 | 82 deg @ 128 | 149 |

Fire resistance testing of current commercially available panels were carried out concurrently with fire resistant building panels made according to samples 2 and 3 of Example 3 of the present disclosure. The results below in Table 7 provide a comparison of the Fire Ratings achieved by each. In the exemplary embodiments the finishing layer comprises a fiber cement layer having a thickness of approximately 4.5 mm (0.2 inch).

TABLE 7
Fire resistance tests results and Fire Ratings

| | Thickness | Time to 140 deg C. | Fire Rating |
|---|---|---|---|
| Product | (mm) | (minutes) | (minutes) |
| Example 3, | 16 | 169 C. @ 51 | 53 |
| Sample 2 | 25 | 164 C. @ 80 | 78 |
| | 32 | 163 C. @ 120 | 119 |
| | 40 | 81 C. @ 123 | 143 |
| Example 3, | 16 | 163 C. @ 60 | 60 |
| Sample 3 | 28 | 164 C. @ 81 | 82 |
| | 35 | 164 C. @ 124 | 126 |
| | 40 | 82 C. @ 128 | 147 |

It will be appreciated that the illustrated fire resistant building panel provides a single, integrally formed product capable of providing both fire resistance and the mechanical and physical properties required by a building cladding material.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and not all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

It will of course be understood that the disclosure is not limited to the specific details described herein, which are given by way of example only, and that various modifications and alterations are possible within the scope of the disclosure as defined in the appended claims.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as ‘can’, ‘could’, ‘might’, or ‘may’, unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase ‘at least one of X, Y, and Z’ unless specifically stated otherwise, is otherwise understood with the context as used in general to convey that an item, term, etc. may be either X, Y or Z. Thus, such conjunctive language is not generally intended to imply that certain embodiments require the presence of at least one of X, at least one of Y, and at least one of Z.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used in conjunction with fire resistant building panels and are described herein with reference to this application. However, it will be appreciated that the disclosure is not limited to this particular field of use.

Some embodiments have been described in connection with the accompanying drawings. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A fire resistant building panel comprising:
a first major face;
a second major face;
a fire resistant body, said fire resistant body comprising:
a binder comprising a calcareous material and a siliceous material, wherein the calcareous material comprises Portland cement, the Portland cement comprising 25-35 parts by weight of the total weight of the fire resistant body, and wherein the siliceous material comprises ground silica, the ground silica comprising 40-60 parts by weight of the total weight of the fire resistant body;
at least one additive comprising a density modifying additive in the form of an expanded mineral, the expanded mineral comprising 15-20 parts by weight and an air entrainment agent in the form of aluminum powder, the air entrainment agent comprising 0.05-1 parts by weight of the total weight of fire resistant body; and
at least one fiber material comprising cellulose fibers, the cellulose fibers comprising approximately 0.05 parts by weight of the total weight of the fire resistant body;
a finishing layer secured to either the first major face of the fire resistant building panel or the second major face of the fire resistant building panel; and
wherein the fire resistant body is disposed between the first major face and the second major face.

2. The fire resistant building panel according to claim 1, wherein the fire resistant body has a thickness of greater than or equal to 15 mm and less than or equal to 60 mm.

3. The fire resistant building panel according to claim 1, wherein the first major face of the fire resistant building panel is configured for engaging with a building substrate.

4. The fire resistant building panel according to claim 1, wherein either one or other, or both of the first major face and second major face of the fire resistant building panel are integrally formed with the fire resistant body of the fire resistant building panel.

5. A fire resistant building panel comprising:
a first major face configured for engaging with a building substrate;
a second major face configured to form a cladding face;
a finishing layer secured to at least one of the first major face of the fire resistant building panel and the second major face of the fire resistant building panel; and
a fire resistant body comprising a binder, at least one additive, and at least one fiber material, wherein the binder comprises a calcareous material and a siliceous material;
wherein the fire resistant body is disposed between the first major face and the second major face.

6. The fire resistant building panel according to claim 5, wherein either one or other, or both of the first major face and second major face of the fire resistant building panel are integrally formed with the fire resistant body of the fire resistant building panel.

7. The fire resistant building panel according to claim 5, wherein the fire resistant body has a thickness of greater than or equal to 15 mm and less than or equal to 60 mm.

8. The fire resistant building panel according to claim 5, wherein the finishing layer comprises a fiber cement layer.

9. The fire resistant building panel according to claim 5, wherein the finishing layer comprises a thickness greater than or equal to 3 mm and less than or equal to 8 mm.

10. The fire resistant building panel according to claim 5, wherein the finishing layer comprises one or more layers, wherein, when the one or more layers are applied to the fire resistant body, the combined thickness of the fire resistant body and the one or more finishing layers ranges between 18 mm and 76 mm.

11. The fire resistant building panel according to claim 5, wherein the calcareous material comprises hydrated lime between approximately 35 and 40 parts by weight of the total weight of the fire resistant body.

12. The fire resistant building panel according to claim 5, wherein the siliceous material comprises between approximately 5 and 60 parts by weight of the total weight of the fire resistant body.

13. The fire resistant building panel according to claim 5, wherein the at least one additive is a density modifying additive, the density modifying additive comprising at least one of expanded minerals, hollow microspheres, and air.

14. The fire resistant building panel according to claim 5, wherein the at least one fiber material comprises at least one of natural organic fibers, synthetic organic fibers, and synthetic inorganic fibers.

15. The fire resistant building panel according to claim 5, wherein the calcareous material comprises Portland cement, Portland cement comprising 10-20 parts by weight of the total weight of the fire resistant body; wherein the siliceous material comprises micro silica, the micro silica comprising 5-15 parts by weight of the total weight of the fire resistant body; wherein the at least one additive comprises a density modifying additive and a filler, wherein the density modifying additive is in the form of microspheres having a density of less than 1 gm/cc and the filler is in the form of anhydrous calcium magnesium carbonate mineral, wherein the ratio of the density modifying additive and the filler is such that the density of the fire resistant body is between approximately 0.40-0.50 gm/cc and wherein the at least one additive comprises 20-70 parts by weight of the total weight of the fire resistant body; and wherein the at least one fiber material comprises a mixture of cellulose fibers and basalt fibers, wherein the cellulose fibers and basalt fibers are provided in a ratio of approximately 2:1 and comprise between approximately 3 and 10 parts by weight of the total weight of the fire resistant body.

16. The fire resistant building panel according to claim 5, wherein the calcareous material comprises Portland cement, the Portland cement comprising 25-35 parts by weight of the total weight of the fire resistant body; wherein the siliceous material comprises ground silica, the ground silica comprising 40-60 parts by weight of the total weight of the fire resistant body; wherein the at least one additive comprises a density modifying additive in the form of an expanded mineral, the expanded mineral comprising 15-20 parts by weight of the total weight of the fire resistant body and an air entrainment agent in the form of aluminum powder, wherein the air entrainment agent comprises 0.05-1 parts by weight of the total weight of the fire resistant body; and wherein the at least one fiber material comprises cellulose fibers, wherein the cellulose fibers comprise approximately 0.05 parts by weight of the total weight of the fire resistant body.

17. A method of making a fire resistant building panel comprising the steps of:
(a) providing a finishing layer of suitable dimensions;
(b) placing a frame on the finishing layer to define boundaries of a fire resistant body;
(c) mixing a binder, wherein the binder comprises a calcareous material and a siliceous material, at least one additive, and at least one fiber material together with water to form a slurry;
(d) introducing the slurry onto the finishing layer in the frame until the slurry has reached a required depth;
(e) allowing the slurry to sit for an initial period of time to allow the slurry to form a partially cured fire resistant body;
(f) removing the frame; and
(g) allowing the partially cured slurry to fully cure.

18. The method of making a fire resistant building panel according to claim 17, wherein the method further comprises applying a second finishing layer to the partially cured fire resistant body after the removing of the frame and before allowing the partially cured slurry to fully cure.

19. The method of making a fire resistant building panel according to claim 17, wherein the finishing layer is an uncured (green sheet) fiber cement layer.

20. The method of making a fire resistant building panel according to claim 19, wherein the slurry and uncured fiber cement finishing layer or layers are co-cured to form an integrally formed fire resistant building panel.
